(19) United States
(12) Patent Application Publication
(10) Pub. No.: US 2026/0234426 A1
(43) Pub. Date: Aug. 13, 2026

(54) A COMPOSITION FOR DYEING A SUBSTRATE AND USE THEREOF

(71) Applicant: STAEDTLER SE, Nürnberg (DE)

(72) Inventor: Arno CASTNER, Nürnberg (DE)

(21) Appl. No.: 19/150,245

(22) PCT Filed: Jan. 29, 2024
(86) PCT No.: PCT/EP2024/025053

§ 371 Date: Jul. 23, 2025

(30) Foreign Application Priority Data
Feb. 3, 2023 (DE) 10 2023 102 696.8

(51) Int. Cl. C09D 11/17; C08K 3/04; C08K 5/053; C08K 5/06; C08K 5/21; C09B 48/00

(52) U.S. Cl. CPC C09D 11/17; C08K 3/04; C08K 5/053; C08K 5/06; C08K 5/21; C09B 48/00

(57) ABSTRACT

A composition for dyeing a substrate, including: —10 to 70 wt % of water; —0.025 to 12.5 wt % of a colorant; and —0.1 to 10 wt % of a tetrahydric alcohol, each based on the total weight of the composition; wherein the tetrahydric alcohol has at least 5 carbon atoms; and the use of the composition for dyeing a substrate for producing a film on a substrate.

### FIELD OF THE INVENTION

The present invention relates to a composition for dyeing a substrate.

The invention also relates to the use of the composition for dyeing a substrate for producing a film on a substrate.

### BACKGROUND OF THE INVENTION

Aqueous writing fluids, such as inks, are known from the prior art and generally comprise water as solvent and pigments or water-soluble dyes as colorants. They also generally comprise further additives, for example surfactants, emulsifiers, preservatives or humectants.

Pigmented inks (dyes) have been known for many years, in particular for artistic applications (painting, drawing etc.). These are frequently formulated with plastic dispersions as binders and/or with wetting agents.

The “cap-off time” (COT) of a writing fluid describes a period in which the writing fluid does not dry in a writing or application device when stored with the writing tip unsealed or with the closure cap removed. For an application of a writing fluid in practice, it is advantageous if the writing or other application device can remain open over a relatively long period of time, preferably over several hours or days, without the writing fluid drying in.

Water-based writing fluids known from the prior art can be divided into the following three groups:
a) inks which are intended to have a very good COT. These contain to a high degree what are known as drying retarders or humectants in order to prevent the writing tip from drying on or out (fineliner, fiber painter). Such inks can contain only small amounts of binder owing to the high proportion of drying retarders or humectants. These smears therefore generally have very long drying times and poor stability. Writing fluids of this type are generally suitable only for absorbent substrates, for example paper.
b) inks which are intended to dry quickly and permanently on non-absorbent substrates. Unfortunately, these usually have a completely unsatisfactory COT.
c) inks which offer a compromise from a) & b), i.e. have a good COT and satisfactory stability, but only on absorbent substrates.

EP 3 613 814 B1 describes, for example, a writing, marking and/or drawing fluid which contains an aqueous pigment preparation, a binder, a base and a dispersing wetting agent, wherein an aqueous solution of a modified polymer having pigment-affine groups is present as dispersing wetting agent.

Pigment liner inks known from the prior art contain 20% by mass of urea and a further 15% of humectant in order to achieve a COT of 18 hours. The addition of urea has the effect that the smear nevertheless dries satisfactorily quickly on moderately absorbent substrates and has a usable stability after a relatively long drying time. The urea crystallizes out in the process.

On unfavorable, poorly absorbent types of paper or even on filmed substrates (for example photographic prints, laminated papers etc.), on the other hand, satisfactory drying or stability of the smear does not occur even after hours or days. The consequence is that the smear smears or dyes on contact. Furthermore, the high proportion of urea leads to impairment of the water resistance of the smear and the urea tends to decompose with formation of CO₂ and ammonia in the alkaline range and further pH increase on relatively long storage of the inks (in particular at elevated temperatures in accordance with a T50 storage test). The consequence is the gradual destabilization of the inks.

There are alcohol-based inks (Lumocolor permanent, whiteboard markers) which have provided a solution to this problem for about twenty years using the so-called “dry safe” technology, namely have both a very good COT and a short drying time and also a very good stability. Here, special wax additives which are moderately soluble in the ink provide protection against drying out, in that the wax which is dissolved until saturation precipitates at the tip when the pencil is “left open” and forms a very thin barrier film which protects against further loss of solvent and therefore drying out. However, this film is mechanically so unstable that it tears open on the slightest contact of the tip with the substrate and immediately ensures ink flow. Corresponding solutions for water-based writing fluids do not exist.

### OBJECT OF THE INVENTION

It is accordingly the object of the present invention to provide a water-based writing fluid which overcomes drawbacks of the prior art, in particular to provide an aqueous writing fluid with excellent cap-off-time (COT) which nevertheless has very short drying times and excellent stability on all types of substrates, in particular also on non-absorbent surfaces, preferably a corresponding aqueous writing fluid which has a reduced proportion of urea or is even free of urea.

### DISCLOSURE OF THE INVENTION

This object is achieved according to the subject matter of the independent claims. Preferred embodiments result from the dependent claims and the following description.

The object is achieved in particular by a composition for dyeing a substrate comprising:
from 10 to 70% by weight of water;
from 0.1 to 50% by weight of a colorant; and
from 1 to 6% by weight of a tetrahydric alcohol,
each based on the total weight of the composition;
wherein
the tetrahydric alcohol has at least 5 carbon atoms.

The object is further achieved by the use of the composition for dyeing a substrate according to the present invention for producing a film on an absorbent substrate.

### Composition for Dyeing a Substrate

The composition according to the present invention is suitable and preferably intended for dyeing a substrate.

### Dyeing

The dyeing comprises or consists preferably of writing, drawing, painting, printing, spraying or a combination of two or more thereof.

### Substrate

The substrate is preferably an absorbent substrate, for example an absorbent writing substrate, further preferably drawing board or paper, particularly preferably watercolour paper, or a non-absorbent substrate, for example a synthetic substrate or a plastic substrate, particularly preferably a synthetic or plastic film, or a mixed media substrate, i.e. for example one of an absorbent material and a non-absorbent material, or a canvas. It is also possible to provide any other suitable substrate, for example wood, stone, eggshells etc.

### Water

The composition according to the invention for dyeing a substrate contains water in an amount of 10 to 70 wt %, based on the total weight of the composition. It is preferred that deionized or demineralized water is used as water. This makes it possible to avoid the introduction of unwanted impurities, such as, for example, hardening agents such as calcium and magnesium or the like.

It may be provided that the composition contains the water as the predominant solvent, preferably in an amount of at least 90 vol %, based on the total amount of solvent in the composition. It is particularly preferred that the composition contains water as the only solvent. It is preferred that the composition contains water in an amount of at least 15 wt %, particularly preferably at least 20 wt %, most preferably at least 25 wt %, each based on the total weight of the composition.

It is preferred that the composition contains water in an amount of at most 65 wt %, moreover preferably at most 60 wt %, further preferably at most 55 wt %, more preferably at most 50 wt %, most preferably at most 45 wt %, for example at most 40 wt %, each based on the total weight of the composition.

It is preferred that the composition contains water in an amount of 15 to 65 wt %, moreover preferably 20 to 40 wt %, most preferably 25 to 35 wt %, for example about 30 wt %, each based on the total weight of the composition.

With the stated preferred amounts of water in the composition, an optimized dyeing on the one hand and usability on the other hand could be achieved.

### Further Solvent

It may be provided that water is the only solvent in the composition according to the invention for dyeing a substrate. Alternatively, it may be provided that the composition according to the invention for dyeing a substrate comprises a further solvent in addition to the water.

It may be provided that the composition for dyeing a substrate contains the further solvent in an amount of at least 1 wt %, particularly preferably at least 5 wt %, most preferably at least 10 wt %, each based on the total weight of the composition.

It is preferred that the composition for dyeing a substrate contains the further solvent in an amount of at most 40 wt %, moreover preferably at most 35 wt %, further preferably at most 30 wt %, more preferably at most 20 wt %, most preferably at most 15 wt %, each based on the total weight of the composition.

It is preferred that the composition for dyeing a substrate contains the further solvent in an amount of 1 to 40 wt %, moreover preferably 5 to 20 wt %, most preferably 10 to 15 wt %, each based on the total weight of the composition.

It is preferred that the further solvent is a water-soluble organic solvent, further preferably an alcohol, moreover preferably a polyhydric alcohol, most preferably glycerol or a glycol, e.g. 1,2-propanediol.

By adding the further solvent to the composition according to the invention, an improved solubility behavior for substances, such as pigments or other colorants, which are sparingly soluble in water, can be achieved. In addition, the efficacy of the tetrahydric alcohol as a cap-off additive can be increased in a synergistic manner. Finally, by adding a suitable solvent, the film formation and thus the stability of the smear can be positively influenced.

### Colorant

The composition according to the invention for dyeing a substrate contains a colorant in an amount of 0.025 to 12.5 wt %, based on the total weight of the composition.

It is preferred that the colorant is a dye, a pigment or a mixture of two or more thereof.

In particular, water-soluble dyes, preferably water-soluble dyes based on food dyes and/or acid dyes and/or basic dyes, can be used as dye.

The dyes listed below have proved to be particularly suitable:
Food dyes from the group: E 110, CI 15985, Food Yellow 3; E 104, CI 47005, Food Yellow 13; E 102, CI 19140, Food Yellow 4; E 124, CI 16255, Food Red 7; E 127, CI 45430, Food Red 14; E 133, CI 42090, Food Blue 2; E 131, CI 42051, Food Blue 3 and/or Acid dyes from the group: Acid Yellow 23, CI 1910; Acid Red 18, CI 16255; Acid Red 51, CI 45430; Acid Orange 4, CI 16230; Acid Blue 93; Acid Blue 9, CI 42090; Acid Blue 104, CI 42735; Acid Violet 49, CI 42640.

Basic dyes, preferably dyes from the group of the xanthene, coumarin and rhodamine dyes, for example Basic Violet 11, Basic Yellow 40, Basic Blue 3, Basic Blue 7, Basic Red 1, Basic Green 1 Organic pigments, moreover preferably quinacridones, phthalocyanine, metal complex, dioxazine, isoindoline, isoindolinone, benzimidazolone, anthraquinone, arylide, perinone, perylene, naphthol, diketopyrrolopyrrole or azo pigments, particularly preferably magenta red P.R. 122 or other quinacridones and/or inorganic pigments, for instance titanium dioxide, iron oxide, ultramarine or carbon black, can preferably be used as pigments.

By means of the colorants stated as preferred, a particularly brilliant, strong and stable dyeing can be achieved. It is preferred that the composition contains the colorant in an amount of at least 0.05 wt %, particularly preferably at least 0.075 wt %, each based on the total weight of the composition.

It is preferred that the composition contains the colorant (or the colorant preparation) in an amount of at most 11.25 wt %, moreover preferably at most 10 wt %, further preferably at most 8.75 wt %, more preferably at most 7.5 wt %, most preferably at most 6.25 wt %, for example at most 5 wt %, each based on the total weight of the composition.

It can be provided that the pigments are present and used as a constituent of a pigment preparation.

It is preferred that the composition contains the colorant in an amount of 0.025 to 10 wt %, moreover preferably 0.05 to 7.5 wt %, most preferably 0.075 to 5 wt %, each based on the total weight of the composition.

If the colorant is a dye, it is preferred that the composition contains the colorant in an amount of 0.025 to 3 wt %, moreover preferably 0.05 to 2 wt %, most preferably about 0.1 to 1 wt %, each based on the total weight of the composition.

If the colorant is a pigment, it is preferred that the composition contains the colorant in an amount of 0.25 to 10 wt %, moreover preferably 1.25 to 7.5 wt %, most preferably 2.5 to 5 wt %, for example about 4.8 wt %, each based on the total weight of the composition.

In pastel shades, the pigment content can be reduced to 0.025 wt %.

By means of the amounts of colorant stated as preferred, an optimal dyeing can be achieved.

### Tetrahydric Alcohol

The composition according to the invention for dyeing a substrate contains 0.1 to 10 wt % of a tetrahydric alcohol, based on the total weight of the composition.

The tetrahydric alcohol has at least 5 carbon atoms. The tetrahydric alcohol preferably has at most 22 carbon atoms, moreover preferably 5 to 18 carbon atoms, furthermore preferably 5 to 15 carbon atoms, likewise preferably 5 to 12 carbon atoms, most preferably 5 to 10 carbon atoms.

The tetrahydric alcohol is preferably contained in an amount of at least 1 wt %, moreover preferably at least 2 wt %, further preferably at least 3 wt %, most preferably at least 4 wt %, based on the total weight of the composition.

The tetrahydric alcohol is preferably contained in an amount of at most 9 wt %, moreover preferably at most 8 wt %, further preferably at most 7 wt %, most preferably at most 6 wt %, based on the total weight of the composition.

The tetrahydric alcohol is preferably contained in an amount of 1 to 9 wt %, moreover preferably 2 to 8 wt %, further preferably 3 to 7 wt %, most preferably 4 to 6 wt %, for example about 5 wt %, based on the total weight of the composition.

Alcohols are understood to be organic compounds which have one or more functional hydroxyl group(s) (—OH). Polyhydric alcohols have a plurality of hydroxyl groups. Tetrahydric alcohols have four hydroxyl groups.

In addition to the four hydroxyl groups, the tetrahydric alcohol contained in the composition according to the invention for dyeing a substrate has an organic moiety which has at least 5 carbon atoms. This organic moiety can be a hydrocarbylene group, in particular a C₅ to C₂₂, preferably C₅ to C₁₈, further preferably C₅ to C₁₅, moreover preferably C₅ to C₁₂, most preferably C₅ to C₁₀ hydrocarbylene group or a heterohydrocarbylene group, in particular a C₅ to C₂₁, preferably C₅ to C₁₈, further preferably C₅ to C₁₅, moreover preferably C₅ to C₁₂, most preferably C₅ to C₁₀ heterohydrocarbylene group.

According to the IUPAC definition, hydrocarbyl is the designation for monovalent groups which result from removal of a hydrogen atom H from a hydrocarbon molecule. Accordingly, according to the present application, a hydrocarbylene group which results from removal of at least one hydrogen atom H, in particular of four hydrogen atoms, from a hydrocarbon molecule.

A heterohydrocarbylene group according to the present disclosure is a hydrocarbylene group in which at least one of the carbon atoms is replaced by a heteroatom, in particular by a heteroatom selected from the group consisting of O, N, S and P.

The hydrocarbylene group can be an alkylene group, an arylene group, an alkene group, an alkyne group, an alkylarylene group, an arylalkylene group etc. The hydrocarbylene group can be an alkylene group.

The hydrocarbylene group can be in particular a C₅ to C₂₂ alkyl group, preferably C₅ to C₁₈ alkyl group, further preferably C₅ to C₁₅ alkyl group, moreover preferably C₅ to C₁₂ alkyl group, most preferably C₅ to C₁₀ alkyl group.

Particularly preferably, the hydrocarbylene group is a tert-pentylene group.

The heterohydrocarbylene group can comprise one or more ether groups, a thioether group, an amine group, in particular a secondary amine group, an alkylphosphine group etc. between two or more hydrocarbylene groups. The heterohydrocarbylene group can comprise an ether group between two hydrocarbylene groups.

The heterohydrocarbylene group can be a C₅ to C₂₂ heteroalkyl group, preferably C₅ to C₁₈ heteroalkyl group, further preferably C₅ to C₁₅ heteroalkyl group, moreover preferably C₅ to C₁₂ heteroalkyl group, most preferably C₅ to C₁₀ heteroalkyl group. In this context, a heteroalkyl group is an alkyl group in which one or more carbon atoms are replaced by one or more heteroatoms, such as, for instance, O, S, N or P.

Preferably, the heterohydrocarbylene group is a C₅ to C₂₂ heteroalkyl group, preferably C₅ to C₁₈ heteroalkyl group, further preferably C₅ to C₁₅ heteroalkyl group, moreover preferably C₅ to C₁₂ heteroalkyl group, most preferably C₅ to C₁₀ heteroalkyl group, which contains an ether bond, i.e. in which formally one of the carbon atoms of the alkyl group is replaced by an oxygen atom.

It is preferred that the tetrahydric alcohol has a molecular weight of 100 to 1,000 g/mol, moreover preferably 100 to 750 g/mol, further preferably 100 to 500 g/mol, further preferably 100 to 300 g/mol, most preferably from 130 to 230 g/mol, for example from 136 to 223 g/mol. It is preferred that the tetrahydric alcohol has a solubility in deionized water at 20° C. of 10 to 100 g/L, preferably of 15 to 80 g/L, most preferably of 21 to 70 g/L.

It is preferred that the tetrahydric alcohol is symmetrical, in particular has a symmetry which has the effect that the tetrahydric alcohol does not have a dipole character. It is preferred that the tetrahydric alcohol is symmetrical with respect to the four hydroxyl groups of the tetrahydric alcohol. It is preferred that the tetrahydric alcohol has a plane of symmetry. It is preferred that the tetrahydric alcohol has a plane of symmetry, wherein two of the four hydroxyl groups of the tetrahydric alcohol are arranged on one side of the mirror plane and the two remaining hydroxyl groups of the tetrahydric alcohol are arranged on the other side of the mirror plane.

Preferably, the tetrahydric alcohol has the following formula (1)

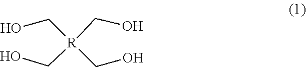

wherein R is a C₁ to C₁₈ hydrocarbylene group or a C₁ to C₁₇ heterohydrocarbylene group having 1 to 3 heteroatoms independently selected from O, N, S and P.

Preferably, R in the formula (1) is a C₁ to C₁₂ hydrocarbylene group or a C₁ to C₁₁ heterohydrocarbylene group having 1 to 2 heteroatoms independently selected from O and S. Moreover preferably, R in the formula (1) is a C₁ to C₈ hydrocarbylene group or a C₁ to C₈ heterohydrocarbylene group having a heteroatom independently selected from O and S. Furthermore preferably, R in the formula (1) is a C₁ to C₁₀ hydrocarbylene group or a C₁ to C₆ heterohydrocarbylene group having O (oxygen) single heteroatom.

Preferably, R in the formula (1) is a C₁ to C₁₂ alkylene group or a C₁ to C₁₁ heteroalkylene group having 1 to 2 heteroatoms independently selected from O and S. Moreover preferably, R in the formula (1) is a C₁ to C₈ alkylene group or a C₁ to C₆ heteroalkylene group having a heteroatom independently selected from O and S. Furthermore preferably, R in the formula (1) is a C₁ to C₆ alkylene group or a C₁ to C₆ heteroalkylene group having O (oxygen) single heteroatom.

It is most preferred that the tetrahydric alcohol is selected from tetrahydric alcohols of formulae (2) and (3)

(2) pentaerythritol

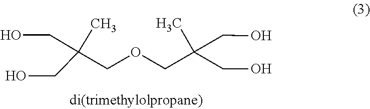

The tetrahydric alcohol acts as a cap-off additive in the composition according to the invention for dyeing a substrate. A cap-off additive improves the “cap-off-time”. “Cap-off-time” is to be understood as meaning the time for which a writing device or a writing system can remain open, i.e. unclosed, can be stored or can remain unused, without drying in in the process.

### Binder

It may be provided that the composition for dyeing a substrate further comprises 0.1 to 50 wt % of a binder.

It is preferred that the composition contains the binder in a total amount of at least 5 wt %, particularly preferably at least 10 wt %, further preferably at least 20 wt %, moreover preferably 25 wt %, most preferably at least 28 wt %, each based on the total weight of the composition.

It is preferred that the composition contains the binder in a total amount of at most 45 wt %, particularly preferably at most 40 wt %, for example about 38 wt %, each based on the total weight of the composition.

It is preferred that the composition contains the binder in a total amount of 5 to 45 wt %, particularly preferably 10 to 40 wt %, further preferably 20 to 40 wt %, most preferably about 25 to 38 wt %, for example about 28 to 38 wt %, each based on the total weight of the composition. Corresponding amounts of binder in the composition support the solubility and efficacy of the tetrahydric alcohol.

The binder may be used as solid and/or as aqueous binder preparation in the composition, i.e. be used in these forms for producing the composition. An aqueous binder preparation in this context is in particular a binder solution or a binder dispersion.

It is preferred that a binder dispersion is used for producing the composition according to the invention. The amount of the binder in the composition is stated in such a case with reference to the total weight of the binder dispersion (including solvent etc.). By using a corresponding binder dispersion for producing the composition according to the invention, advantageous mixing in the composition can be achieved.

It may be provided that the binder is a synthetic polymeric binder, preferably a polyacrylate, a polyurethane, a polyester, a sulfopolyester, a maleate resin, or a copolymer of two or more thereof, or a wax, for example beeswax.

For example, the binder may be Acronal 12DE (dispersion of an acrylonitrile-acrylic ester copolymer, BASF) Neocryl XK166N (dispersion of an acrylstyrene copolymer, Covestro) NeoRez R-3972 (polyurethane dispersion, Covestro) Eastek 1000 (colloidal solution of a sulfopolyester, Eastman) or Neocryl XK-39 (alkali-soluble polyacrylate dispersions, Covestro).

It is preferred that the binder is an acrylstyrene copolymer, a sulfopolyester or a mixture thereof, preferably a mixture of an acrylstyrene copolymer and a sulfopolyester. It is further preferred that the binder is a mixture of an acrylstyrene copolymer and a sulfopolyester in a weight ratio of 10:1 to 1:2, moreover preferably 5:1 to 1:1.5, further preferably 3:1 to 1:1, for example about 2:1.

For example, the binder may be a mixture of Neocryl XK166N (dispersion of an acrylstyrene copolymer, Covestro) and Eastek 1000 (colloidal solution of a sulfopolyester, Eastman) in a weight ratio of 2:1.

Alternatively, it may be provided that the binder preferably has an acid number of at most 250 mg KOH/g dry matter, moreover preferably of at most 220 mg KOH/g dry matter, furthermore preferably at most 200 mg KOH/g dry matter, more preferably at most 180 mg KOH/g dry matter, even more preferably at most 170 mg KOH/g dry matter, most preferably at most 160 mg KOH/g dry matter, for example about 130 mg KOH/g or 160 mg KOH/g dry matter.

The binder may preferably have an acid number of 50 to 250 mg KOH/g dry matter, moreover preferably of 60 to 220 mg KOH/g dry matter, furthermore preferably 70 to 220 mg KOH/g dry matter, more preferably 80 to 180 mg KOH/g dry matter, even more preferably 100 to 170 mg KOH/g dry matter, moreover preferably 100 to 160 mg KOH/g dry matter, most preferably 110 to 160 mg KOH/g dry matter, such as about 110 to 130 mg KOH/g dry matter, for example about 130 mg KOH/g dry matter or 160 mg KOH/g dry matter. With binders having a corresponding acid number, advantageous effects with regard to redissolvability could be achieved by means of a basic composition for watercolouring.

The binder may preferably be a polymeric binder. The binder may preferably be a polymer resin. It may be provided that the binder has carboxyl groups and/or nitrile groups and/or sulfonyl groups, preferably has carboxyl groups. This makes it possible to achieve a particularly good dyeability, in particular with basic dyes. It is preferably provided that the binder is a polymer resin which comprises carboxyl-containing monomer units. It is particularly preferred that the binder comprises or consists of a polyacrylate resin.

It may be provided that the binder dispersion has a pH of at most 7, preferably of less than 7, moreover preferably of 1 to 5, further preferably of 1.5 to 3, most preferably of 1.9 to 2.5. It may be provided that the binder dispersion in acidic or neutral pH ranges (at pH≤7) is a low-viscosity, white or translucent binder particle dispersion, wherein these binder particles increasingly go into solution at higher pH values until a clear, transparent and highly viscous solution is formed.

It may be provided that the binder dispersion has a solids content of 30 to 60 wt %, preferably 40 to 50 wt %, particularly preferably 43 to 47 wt %, most preferably 44 to 46 wt %, each based on the total weight of the binder dispersion.

The binder may be an alkali-soluble acrylate dispersion. The binder may be an alkali-soluble polyacrylate dispersion. The binder may be an acidic acrylate dispersion. The binder may be an acidic polyacrylate dispersion. The binder may be an ASE thickener. Commercially available examples of corresponding binders are, for example, Joncryl 142, 661, 662, 667 (BASF), Texicryl 13-812, 13-825 (Scott Bader), NeoCryl BT-9, BT-21, BT-24, BT-100, BT-107, BT-207 (DSM), NeoCryl XK-39 (DSM), GLASCOL LE510, LE520 etc. (BASF) or Lucidene 198 (Brenntag). With corresponding alkali-soluble polyacrylate dispersions, the most pronounced effects according to the invention were achieved, namely a particularly readily adjustable water resistance.

It may be provided that the binder, in particular the binder dispersion, comprises binder particles. It may be provided that the binder particles have an average particle diameter of at least 50 nm, preferably of at least 100 nm. The particle diameter may be determined by dynamic light scattering according to ASTM E 3247-20 in the version valid at the priority date. By means of correspondingly large diameters of the binder particles, it can be achieved that the composition does not penetrate too deeply into the absorbent substrate, whereby the watercolourability, i.e. the later paintability of the ink on the substrate, can be improved.

### Preservative/Biocide

It may be provided that the composition further comprises 0.01 to 0.5 wt %, based on the total weight of the composition, of a preservative and/or a biocide. Preferred preservatives are, for instance, a mixture of tert-butyl hydroperoxide and monophenyl glycol ether, particularly preferably a mixture of 12 to 60 wt % tert-butyl hydroperoxide and 3 to 50 wt % monophenyl glycol ether, or a mixture of 1,6-dihydroxy-2,5-dioxahexane and tetramethylolacetylenediurea. Such a preservative is particularly suitable for aqueous solutions and emulsions. A preferred biocide is, for example, a mixture of 2-bromo-2-nitropropane-1,3-diol and 2-octyl-2H-isothiazol-3-one or a mixture of BIT (1,2-benzisothiazolin-3-one), MIT (2-methyl-4-isothiazolin-3-one) and OIT (2-octyl-2H-isothiazol-3-one), which in particular prevents contamination. A further preferred biocide is a mixture of CIT/MIT in a weight ratio of 3:1. A further preferred biocide is 2-bromo-2-nitropropane-1,3-diol. A further preferred biocide is 2-octyl-2H-isothiazol-3-one. A further preferred biocide is phenoxyethanol.

It is preferred that the composition contains the preservative and/or the biocide in a total amount of at least 0.05% by weight, more preferably at least 0.2% by weight, further preferably at least 0.15% by weight, most preferably at least 0.1% by weight, each based on the total weight of the composition.

It is preferred that the composition contains the preservative and/or the biocide in a total amount of at most 0.4 wt %, particularly preferably at most 0.3 wt %, further preferably at most 0.25 wt %, most preferably at most 0.2 wt %, each based on the total weight of the composition.

It is preferred that the composition contains the preservative and/or the biocide in a total amount of 0.025 to 0.4 wt %, particularly preferably 0.05 to 0.3 wt %, further preferably 0.75 to 0.2 wt %, most preferably about 0.1 wt %, each based on the total weight of the composition.

### Humectant

It may be provided that the composition further comprises 0.01 to 20 wt %, based on the total weight of the composition, of a humectant. The humectant is preferably an organic polyol and/or polyglycol and/or a sugar alcohol and/or a polar organic compound which is liquid at room temperature and under normal pressure, particularly preferably selected from the group consisting of diethylene glycol, propylene glycol, 1,2-propanediol, glycerol, trimethylolpropane, di-trimethylolpropane, neopentyl glycol, erythritol, dimethyl sulfoxide, pyrrolidones, in particular 2-pyrrolidone or N-methyl-2-pyrrolidone (NMP) and mixtures thereof, particularly preferably 1,2-propanediol.

A combination of an organic polyol and/or polyglycol and/or a polar organic compound which is liquid at room temperature and under normal pressure as humectant on the one hand and pentaerythritol and/or di(trimethylolpropane) on the other hand is preferred. A combination of an organic polyol and/or polyglycol as humectant on the one hand and pentaerythritol and/or di(trimethylolpropane) on the other hand is preferred. Moreover, a combination of an organic polyol as humectant on the one hand and pentaerythritol and/or di(trimethylolpropane) on the other hand is preferred. In particular, 1,2-propanediol as humectant in combination with pentaerythritol and/or di(trimethylolpropane) as tetrahydric alcohol is preferred. 1,2-propanediol as humectant in combination with pentaerythritol as tetrahydric alcohol is particularly preferred.

It is preferred that the composition contains the humectant in an amount of at least 1 wt %, particularly preferably at least 5 wt %, further preferably at least 7.5 wt %, most preferably at least 10 wt %, each based on the total weight of the composition.

It is preferred that the composition contains the humectant in an amount of at most 17.5 wt %, particularly preferably at most 15 wt %, further preferably at most 13.5 wt %, each based on the total weight of the composition.

It is preferred that the composition contains the humectant in an amount of 1 to 17.5 wt %, particularly preferably 5 to 15 wt %, further preferably 7.5 to 14.5 wt %, most preferably about 10 to 13.5 wt %, each based on the total weight of the composition.

Corresponding humectants in corresponding concentrations improve the COT and the writing behavior after short time intervals. In addition, the film formation and thus the stability of the smear is positively influenced. In particular, a corresponding synergistic effect can be observed in interaction with the tetrahydric alcohol.

### Surfactant/Surface-Active Substance

It may be provided that the composition further comprises 0.01 to 7 wt %, based on the total weight of the composition, of a surfactant and/or a surface-active substance.

The surfactant may be an emulsifier, a dispersant, a stabilizer or a substrate wetting agent, preferably a silicone surfactant, a fatty alcohol ether sulfate, in particular C12-14 fatty alcohol ether sulfate sodium salt (30 EO), a fatty alcohol ether phosphate, a fatty alcohol phosphate ester, a sulfosuccinate, or the like.

The surfactant is preferably a nonionic surfactant, an anionic surfactant or an amphoteric surfactant.

Stabilizers in the sense of the present disclosure are in particular surface-active substances which stabilize the colloidal particle system by adsorption at the particle interfaces by means of steric, electrostatic or electrosteric interactions against reagglomeration or coagulation and thus prevent sedimentation, syneresis, particle size increase and viscosity increase.

Nonionic surfactants in the sense of the present disclosure may be classified according to the following system. This is the system described by the company Atlas Chemie “HLB-System” (Hydrophilic-Lipophilic-Balance). In the HLB system, each emulsifier is assigned a numerical value, which is called HLB value. The HLB value indicates the hydrophilic-lipophilic equilibrium. All emulsifiers comprise both hydrophilic and lipophilic groups. A lipophilic emulsifier has a low HLB value of below 9.0 and a hydrophilic emulsifier has a high HLB value of above 11.0. Emulsifiers with low HLB values tend to be oil-soluble, while emulsifiers with high HLB values are water-soluble. For example, a water-soluble emulsifier is used when the end product can be diluted with water. O/W emulsifiers have HLB values of between 8 and 18. Hydrophilic emulsifiers with a high HLB value promote the formation of an O/W emulsion.

In the composition according to the invention, the nonionic solubilizers used may preferably be commercial emulsifiers which are obtainable, for example, as viscous solutions and which have been prepared by reacting ethylene oxide with hydrogenated castor oil and can be composed, for example, of 90% by weight of hydrogenated castor oil, 5% by weight of 1,2-propylene glycol and 5% by weight of water. Constituents of emulsifiers of this type can also be fatty acid glycerol polyethylene glycol esters and fatty acid polyethylene glycol esters. They represent the hydrophobic part of the products. The hydrophilic part can consist of polyethylene glycol and glycerol ethoxylate.

Possible emulsifiers which can be considered are preferably nonionic emulsifiers from the groups listed below: alcohol fatty acid esters, ethylene fatty acid esters, polyethylene glycol fatty acid esters, glycerol or polyfatty acid esters, sorbitol fatty acid esters, pentaerythritol fatty acid esters, fatty acid esters of glycerol esters, sucrose fatty acid esters, alcohol polyglycol ethers, fatty acid polyglycol ethers, fatty acid ester polyglycol ethers, fatty amine polyglycol ethers, polyglycol ethers of fatty acid alkanolamides, polyglycol ethers of fats and oils, polypropylene glycol polyglycol ethers, lanolin polyglycol ethers, alcohol polypropylene glycol ethers, fatty acid polypropylene glycol ethers, polypropylene glycol ethers of fatty amines, lanolin polypropylene glycol ethers.

It is preferred that the composition contains the surfactant and/or the surface-active substance in a total amount of at least 0.1 wt %, particularly preferably at least 0.5 wt %, further preferably at least 1 wt %, most preferably at least 1.5 wt %, each based on the total weight of the composition.

It is preferred that the composition contains the surfactant and/or the surface-active substance in a total amount of at most 5 wt %, particularly preferably at most 4 wt %, further preferably at most 3 wt %, most preferably at most 2 wt %, each based on the total weight of the composition.

It is preferred that the composition contains the surfactant and/or the surface-active substance in a total amount of 0.1 to 5 wt %, preferably 0.5 to 4 wt %, further particularly preferably 1 to 3 wt %, most preferably 1.5 to 2 wt %, for example about 1.5 wt %, each based on the total weight of the composition.

By means of corresponding surfactants and/or surface-active substances in corresponding amounts, an improved ink stability and wettability of the substrate to be dyed can be achieved.

### Oligomer/Polymer Having Surface-Active/Pigment-Affine Groups

It may be provided that the composition further comprises a compound having surface-active and/or pigment-affine groups, preferably an oligomer having surface-active and/or pigment-affine groups and/or a polymer having surface-active and/or pigment-affine groups, in an amount of 0.01 to 5 wt %, based on the total weight of the composition.

Pigment-affine groups in the sense of the present disclosure are anchor groups which are selected depending on the pigment type, for example whether this is organic or inorganic.

Surface-active groups in the sense of the present disclosure are groups having an affinity to surfaces and interfaces, for example of glass, metal, plastic, air, binder particles (mineral or organic) or pigments (mineral or organic).

In particular for use together with inorganic or mineral pigments (TiO₂, iron oxide etc.), it is possible to provide compounds having anionic or cationic surface-active and/or pigment-affine groups, in particular amino, phosphate, quaternary ammonium, sulfonate, carboxylate groups etc.

Unmodified organic pigments are usually nonpolar and bear no surface charges. Here, use is usually made of nonionic dispersants having hydrophilic and hydrophobic molecule sections, the nonpolar sections being attached to the pigment surface via Van der Waals interactions (=>see HLB value). Here, the corresponding nonpolar sections are to be regarded as a pigment-affine group. Examples of hydrophobic surface-active and/or pigment-affine groups are, for example, nonylphenol, isotridecyl, isotristyrene, C13, siloxane, novolac groups.

The addition of such compounds having surface-active and/or pigment-affine groups to the pigmented writing fluid has the effect of stabilizing them with respect to agglomeration, sedimentation, syneresis, viscosity drift, fluctuations in color strength, change in hue and further ageing effects, or of improving the compatibility between binder and colorant.

It is preferred that the composition contains the compound having surface-active and/or pigment-affine groups in a total amount of at least 0.1 wt %, particularly preferably at least 0.5 wt %, further preferably at least 0.75 wt %, most preferably at least 1 wt %, each based on the total weight of the composition.

It is preferred that the composition contains the compound having surface-active and/or pigment-affine groups in a total amount of at most 5 wt %, particularly preferably at most 2.5 wt %, further preferably at most 1.5 wt %, most preferably at most 1 wt %, each based on the total weight of the composition.

It is preferred that the composition contains the compound having surface-active and/or pigment-affine groups in a total amount of 0.1 to 5 wt %, particularly preferably 0.5 to 2.5 wt %, further preferably 0.75 to 1.5 wt %, most preferably about 1 wt %, each based on the total weight of the composition.

### Further Constituents

Furthermore, the addition of co-binders (e.g. acrylate polymers without acid number etc.) and co-film-forming agents (texanol, butyl glycol, butyl diglycol etc.) may be provided in order to further optimize the film nature and other application properties of the ink.

Likewise, the addition of waxes may be provided in order to improve the scratch resistance.

It may be provided that the composition is free of urea. In this context, “free of” means that urea has not been actively added to the composition, but is only present at most as an impurity in amounts which cannot be prevented by customary purification methods.

### EMBODIMENTS

In one embodiment, the invention relates to a composition for dyeing a substrate comprising:
from 20 to 40% by weight of water;
from 1 to 6% by weight of a tetrahydric alcohol;
from 0.1 to 0.5% by weight of a biocide;
from 5 to 15% by weight of a humectant;
from 1 to 3% by weight of a surfactant and/or a surface-active substance;
from 1 to 12.5% by weight of a colorant; and
from 25 to 45% by weight of a binder;
each based on the total weight of the composition;
wherein
the tetrahydric alcohol has at least 5 carbon atoms.

In one embodiment, the invention relates to a composition for dyeing a substrate comprising:
from 20 to 40% by weight of water;
from 1 to 6% by weight of a tetrahydric alcohol;
from 0.1 to 0.5% by weight of a biocide;
from 5 to 15% by weight of a humectant;
from 1 to 3% by weight of a surfactant and/or a surface-active substance;
from 1 to 12.5% by weight of a colorant; and
from 25 to 45% by weight of a binder;
each based on the total weight of the composition;
wherein
the tetrahydric alcohol has the following formula (1)

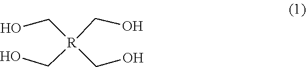

wherein R is a C₁ to C₁₈ hydrocarbylene group or a C₁ to C₁₇ heterohydrocarbylene group having 1 to 3 heteroatoms independently selected from O, N, S and P.

In one embodiment, the invention relates to a composition for dyeing a substrate comprising:
from 20 to 40% by weight of water;
from 1 to 6% by weight of a tetrahydric alcohol;
from 0.1 to 0.5% by weight of a biocide;
from 5 to 15% by weight of a humectant;
from 1 to 3% by weight of a surfactant and/or a surface-active substance;
from 1 to 12.5% by weight of a colorant; and
from 25 to 45% by weight of a binder;
each based on the total weight of the composition;
wherein
the tetrahydric alcohol is selected from tetrahydric alcohols of formulae (2) and (3)

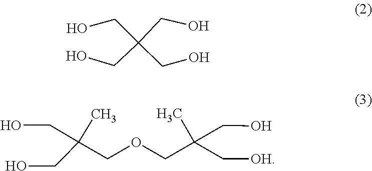

### Production of the Composition for Dyeing a Substrate

The production of the composition for dyeing a substrate can be produced by mixing methods known from the prior art, for example in a mixing vessel into which the constituents of the composition for dyeing a substrate are added. In this case, the constituents are intensively mixed with one another continuously by means of suitable stirring tools in order to distribute them sufficiently uniformly.

It may be provided that the constituents of the composition according to the invention for dyeing a substrate are heated for a sufficient period, preferably 30 to 60 min, preferably to a temperature of 50 to 60° C., in order thus to obtain a particularly homogeneous composition, for example in the form of a dispersion.

After cooling, the soluble constituents of the composition remain permanently dissolved. Without being bound to this presumption, it can be assumed that the tetrahydric alcohol is attached or adsorbed to the particle interfaces (pigments & polymer particles) present in the composition (or is attached to dissolved polymer molecules).

### The Use of the Composition for Dyeing a Substrate

The invention further relates to the use of the composition for dyeing a substrate according to the present invention for producing a film on a substrate.

The use according to the invention can in particular comprise the provision of a substrate, preferably an absorbent substrate, for example an absorbent writing substrate, further preferably drawing board or paper, particularly preferably watercolour paper, or a non-absorbent substrate, for example a synthetic substrate or a plastic substrate, particularly preferably a synthetic or plastic film, or a mixed media substrate, i.e. for example a combination of an absorbent material and a non-absorbent material, or a canvas. It is also possible to provide any other suitable substrate, for example wood, stone, eggshells etc.

It may be provided that the composition according to the invention for dyeing a substrate is then applied to the substrate.

The composition can in this case be applied at least to one surface of the substrate. The composition is in this case applied at least to a part of the corresponding surface. The application can comprise writing, drawing, painting, printing, spraying or a combination of two or more thereof. The application can be effected by means of a paintbrush, a pencil, in particular a watercolor pencil, a print head, a fountain pen holder or another customary application device (e.g. airbrush) or a combination of two or more thereof.

After application has taken place, the applied composition can be dried on the substrate (or partly in the latter if a part of the composition has penetrated into the substrate). The drying can be effected at room temperature (23° C.) under normal atmospheric pressure. The drying can be supported by the supply of heat, passing of a gas flow (air stream) past the composition to be dried, application of a vacuum etc.

### Effect of the Invention

The composition according to the invention for dyeing a substrate surprisingly has excellent cap-off-time (COT) and at the same time a very short drying time and excellent stability on various types of substrates, in particular also on non-absorbent surfaces.

In particular, it has surprisingly been found that the addition of certain tetrahydric alcohols leads to an exceptionally good COT, wherein the other application properties are not impaired, but are even significantly improved. The two substances di-trimethylolpropane (di-TMP) and pentaerythrit (=pentaerythritol) which triggered a particularly pronounced effect have proved to be particularly advantageous.

Furthermore, it is surprisingly possible to formulate the composition according to the invention for dyeing a substrate in a urea-free manner, in particular only using substances which—in contrast to urea—are stable to hydrolysis, do not tend to decompose and have no influence on the long-term pH value of the composition.

The composition according to the invention for dyeing a substrate likewise makes it possible to significantly reduce the humectant content overall compared with that of writing fluids known from the prior art. At the same time, the composition according to the invention makes it possible to significantly increase the binder content. This results in new latitudes and degrees of freedom in the formulation of writing fluids.

### General Definitions

Unless expressly stated otherwise, a feature stated in the singular (a . . . ) also comprises the plural. If, for example, it is stated that the composition according to the invention contains a dye, this also includes the case in which the composition contains a mixture of a plurality of dyes.

Unless expressly stated otherwise, terms such as “comprising”, “containing” etc. comprise the meanings “substantially comprising”, “substantially containing” or “consisting of”.

The amounts stated for the composition according to the invention for dyeing a substrate add up to a total amount of 100 wt % and thus result in the total amount of the composition.

Unless expressly stated otherwise, the term “composition” as used herein refers to the “composition according to the invention for dyeing a substrate”.

### Working Examples

### Formulation Example 1

30.0 g of water
0.10 g of Acticide MBT1 (biocide)
10.0 g of 1,2-propanediol (humectant)
5.0 g of pentaerythritol (tetrahydric alcohol)
1.50 g of C12-14 fatty alcohol ether sulfate Na salt (30EO) (surfactant)
24.0 g of Neocryl XK-166N (first binder)
12.0 g of Eastek 1100 (second binder)
2.50 g of texanol (film-forming agent)
16.0 g of magenta red preparation (30% P.R.122).

The corresponding constituents were mixed, heated to 60° C. for 30 min and then cooled to room temperature.

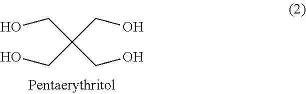

### Formulation Example 2

Formulation Example 2 was prepared as Formulation Example 1, with the only exception that di(trimethylolpropane) was used as tetrahydric alcohol instead of pentaerythritol.

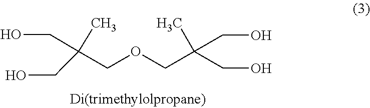

### Formulation Example 3

Formulation Example 3 was prepared as Formulation Example 1, with the only exception that urea was used as humectant instead of 1,2-propanediol.

### Formulation Example 4

36.9 g of water
0.10 g of Acticide MBT1 (biocide)
10.0 g of 1,2-propanediol (humectant)
5.0 g of pentaerythritol (tetrahydric alcohol)
1.50 g of C12-14 fatty alcohol ether sulfate Na salt (30EO) (surfactant)
28.0 g of Neocryl XK-39 (acidic, alkali-soluble binder)
0.7 g of triethanolamine (pH adjuster, base)
20.0 g of carbon black preparation (34% pigment)

### Comparative Formulation 1

Comparative Formulation 1 was prepared as Formulation Example 1, with the only exception that a tetrahydric alcohol was used instead of pentaerythritol with erythritol.

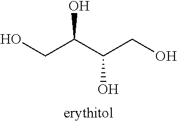

### Comparative Formulation 2

Comparative Formulation 2 was prepared as Formulation Example 1, with the only exception that a hexahydric alcohol (water solubility=>2.4 g/l) was used instead of pentaerythritol with di-pentaerythritol.

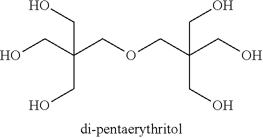 [SMILES: OCC(CO)(CO)COCC(CO)(CO)CO]

### Comparative Formulation 3

Comparative Formulation 3 was prepared as Formulation Example 1, with the only exception that ε-caprolactam was used instead of pentaerythritol.

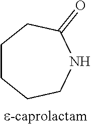

### Comparative Formulation 4

Comparative Formulation 4 was prepared as Formulation Example 1, with the only exception that a hexahydric alcohol was used instead of pentaerythritol with sorbitol.

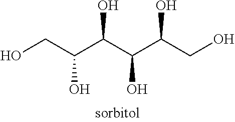 [SMILES: OC[C@@H](O)[C@@H](O)[C@H](O)[C@@H](O)CO]

### Comparative Formulation 5

Comparative Formulation 5 was prepared as Formulation Example 1, with the only exception that ε-caprolactone was used instead of pentaerythritol.

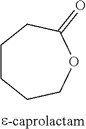

### Comparative Formulation 6

Comparative Formulation 6 was prepared as Formulation Example 1, with the only exception that a dihydric alcohol was used instead of pentaerythritol with neopentyl alcohol.

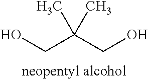

### Comparative Formulation 7

Comparative Formulation 7 was prepared as Formulation Example 1, with the only exception that a trihydric alcohol was used instead of pentaerythritol with 1,1,1-trimethylolpropane (TMP).

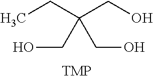

### Comparative Formulation 8

Comparative Formulation 8 was prepared as Formulation Example 1, with the only exception that a pentahydric alcohol was used instead of pentaerythritol with xylitol.

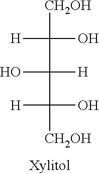

### WORKING EXAMPLES

### Example 1

The composition produced in Formulation Example 1 was dispensed into test pens (fiber pen with capillary reservoir). These were then completed with an extruded POM plastic tip (0.5 mm) and stored horizontally overnight.

A subsequent cap-off test was carried out under standard climatic conditions (23° C., 50% rel. humidity). For this purpose, in each case 3 pens per formulation were used and with these the composition of the formulation example was applied to standard paper, Xerox 80 g as substrate. The caps of the test pens were removed at the start time. The test pens were written on after time intervals of 10 min, 30 min, 60 min and 10 h, i.e. used for writing.

The cap-off test is considered to have passed very well if the pen writes on again spontaneously and forms a homogeneously covering line “+++”. If the pen writes on again satisfactorily after a few millimeters, the test is considered to have passed “+”. If the pen writes on no longer or only after a relatively long “clapping”, the test is considered to have passed “−”.

### Examples 2 to 4

Examples 2 to 4 were carried out as Example 1, with the only exception that the compositions of Formulation Examples 2 to 4 were used in each case instead of the composition of Formulation Example 1.

### Comparative Examples 1 to 8

Comparative Examples 1 to 8 were carried out as Example 1, with the only exception that the compositions of Comparative Formulations 1 to 8 were used in each case instead of the composition of Formulation Example 1.

The results of Examples 1 to 4 and of the experimental examples are shown in Table 1.

TABLE 1

| Cap-off-time | 10 min | 30 min | 60 min | 10 h |
|---|---|---|---|---|
| Example 1 | +++ | +++ | +++ | +++ |
| Example 2 | +++ | ++ | + | +++ |
| Example 3 | +++ | ++ | + | +++ |
| Example 4 | +++ | ++ | + | +++ |
| Comparative | /− | /− | −− | −−− |
| Example 1 | | | | |
| Comparative | /− | − | −− | −−− |
| Example 2 | | | | |
| Comparative | /− | − | −− | −−− |
| Example 3 | | | | |
| Comparative | /− | − | −− | −−− |
| Example 4 | | | | |
| Comparative | /− | − | −− | −−− |
| Example 5 | | | | |
| Comparative | /+ | − | −− | −−− |
| Example 6 | | | | |
| Comparative | /+ | − | −− | −−− |
| Example 7 | | | | |
| Comparative | /− | − | −− | −−− |
| Example 8 | | | | |

+++ pen writes on again spontaneously and homogeneously. =>see text on the previous page
++ pen writes on again almost spontaneously and homogeneously. =>see text on the previous page
+ pen writes on again homogeneously after a short misfire.
− pen writes on again only after a plurality of centimeters
−− pen writes on no longer even after a relatively long clapping
−−− pen unusable, even after a relatively long regeneration time after the wiper has been fitted on again.

In addition, the compositions were tested with regard to their drying time and water resistance. The experimental conditions and results are summarized in Table 2.

TABLE 2

| | Drying time | |
|---|---|---|
| | of the smear (fiber pen | Water resistance |
| | with 0.5 mm POM capillary | of the smear (fiber pen |
| | tip) on non-absorbent | with 0.5 mm POM capillary |
| | substrate (“Byko chart”) | tip) on non-absorbent |
| | standard climate | substrate (“Byko chart”) |
| | ≤6 s: +++ | 10 minutes drying time at |
| | ≤12 s: ++ | standard climate, wiped 5× |
| Application | ≤18 s: + | with a moist cotton wool |
| properties | >18 s: − | rod thereover. |
| Example 1 | ++ | ++ |
| Example 2 | ++ | ++ |
| Example 4 | ++ | ++ |
| Comparative | /− | − |
| Example 1 | | |
| Comparative | /++ | + |
| Example 2 | | |
| Comparative | /− | − |
| Example 3 | | |
| Comparative | /− | − |
| Example 4 | | |
| Comparative | /+ | − |
| Example 5 | | |
| Comparative | /+ | − |
| Example 6 | | |
| Comparative | /− | + |
| Example 7 | | |
| Comparative | /− | − |
| Example 8 | | |

The features of the invention disclosed in the above description and in the claims may be essential both individually and in any combination for the realization of the invention in its various embodiments.

1-11. (canceled)

12. A composition for dyeing a substrate, comprising:
from 10 to 70% by weight of water;
from 0.025 to 12.5% by weight of a colorant; and
from 0.1 to 10% by weight of a tetrahydric alcohol,
each based on total weight of the composition;
wherein
the tetrahydric alcohol has at least 5 carbon atoms.

13. The composition for dyeing a substrate according to claim 12, wherein the dyeing is writing, drawing, painting, printing, spraying or a combination of two or more thereof.

14. The composition for dyeing a substrate according to claim 12, wherein the substrate is an absorbent writing substrate, preferably drawing board or paper, or a non-absorbent substrate, preferably a synthetic film or a plastic film, a mixed media substrate or a canvas.

15. The composition for dyeing a substrate according to claim 14, wherein the substrate is drawing board or paper.

16. The composition for dyeing a substrate according to claim 14, wherein the substrate is a synthetic film or a plastic film, a mixed media substrate or a canvas.

17. The composition for dyeing a substrate according to claim 12, wherein the colorant is a dye, a pigment or a mixture of two or more thereof.

18. The composition for dyeing a substrate according to claim 12, wherein the tetrahydric alcohol has the following formula (1) 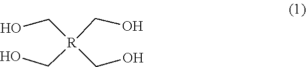
wherein R is a C₁ to C₁₈ hydrocarbylene group or a C₁ to C₁₇ heterohydrocarbylene group having 1 to 3 heteroatoms independently selected from O, N, S and P.

19. The composition for dyeing a substrate according to claim 12, wherein the tetrahydric alcohol is selected from tetrahydric alcohols of formulae (2) and (3)

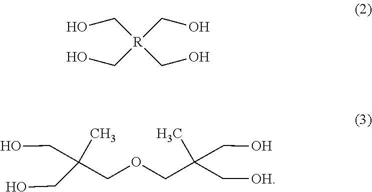

20. The composition for dyeing a substrate according to claim 12, wherein the composition further comprises 0.1 to 50 wt %, based on the total weight of the composition, of a binder.

21. The composition for dyeing a substrate according to claim 12, wherein the composition further comprises 0.01 to 0.5 wt %, based on the total weight of the composition, of a preservative and/or a biocide.

22. The composition for dyeing a substrate according to claim 12, wherein the composition further comprises 0.01 to 20 wt %, based on the total weight of the composition, of a humectant.

23. The composition for dyeing a substrate according to claim 12, wherein the composition further comprises 0.01 to 7 wt %, based on the total weight of the composition, of a surfactant.

24. A method for producing a film on a substrate, comprising the steps of: providing the substrate; and, producing the film on the substrate by using the composition according to claim 12.
